(19) United States
(12) Patent Application Publication
(10) Pub. No.: US 2025/0054284 A1
(43) Pub. Date: Feb. 13, 2025

(54) HEATMAP REDUCTION FOR OBJECT DETECTION

(71) Applicant: QUALCOMM Incorporated, San Diego, CA (US)

(72) Inventors: Youngsaeng JIN, Seoul (KR); Seok-Soo HONG, Seoul (KR); Soyeb Noormohammed NAGORI, San Diego, CA (US); Sanghyuk LEE, Seoul (KR)

(21) Appl. No.: 18/414,246

(22) Filed: Jan. 16, 2024

Related U.S. Application Data
(60) Provisional application No. 63/518,288, filed on Aug. 8, 2023.

(51) Int. Cl. G06V 10/80; G06V 10/77

(52) U.S. Cl. CPC G06V 10/806; G06V 10/7715

(57) ABSTRACT

Systems and techniques are provided for processing confidence maps. For example, a computing device can obtain confidence maps associated with different classes of objects, where each different confidence map is associated with a different class of object. The computing device can determine a maximum value from at least a first value in a first position of a first confidence map and a second value in a first position of a second confidence map. The computing device can generate a combined confidence map for the plurality of confidence maps at least in part by including the maximum value in a first position of the combined confidence map.

### CROSS-REFERENCE TO RELATED APPLICATIONS

This application claims priority to U.S. Provisional Patent Application No. 63/518,288, filed Aug. 8, 2023, which is hereby incorporated by reference, in its entirety and for all purposes.

### FIELD

The present disclosure generally relates to object detection. For example, aspects of the present disclosure relate to systems and techniques for reducing sizes of heatmaps for object detection.

### BACKGROUND

Many devices and systems allow a scene to be captured by generating images (or frames) and/or video data (including multiple frames) of the scene. For example, a camera or a device including a camera can capture a sequence of frames of a scene (e.g., a video of a scene). In some cases, the sequence of frames can be processed for performing one or more functions, can be output for display, can be output for processing and/or consumption by other devices, among other uses.

Object detection can be used to identify an object (e.g., from a digital image or a video frame of a video clip). In some cases, object tracking can be performed to track the object over time (e.g., over a number of frames). Object detection and/or tracking can be used in different fields, including transportation, video analytics, security systems, robotics, aviation, among many others. In some fields, a tracking object can determine positions of other objects (e.g., target objects) in an environment so that the tracking object can accurately navigate through the environment.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described herein for processing one or more confidence maps (e.g., for reducing sizes of the heatmap(s) for object detection). According to some examples, an apparatus for processing one or more confidence maps is provided. The apparatus includes at least one memory and at least one processor coupled to the at least one memory and configured to: obtain a plurality of confidence maps associated with different classes of objects, each different confidence map of the plurality of confidence maps being associated with a different class of object, wherein each confidence map includes a plurality of confidence values in a plurality of positions, each confidence value in a respective position indicating a likelihood that an object of a particular class is located in the respective position; determine a maximum value from at least a first value in a first position of a first confidence map and a second value in a first position of a second confidence map; and generate a combined confidence map for the plurality of confidence maps at least in part by including the maximum value in a first position of the combined confidence map.

In another illustrative example, a method for processing one or more confidence maps is provided. The method includes: obtaining a plurality of confidence maps associated with different classes of objects, each different confidence map of the plurality of confidence maps being associated with a different class of object, wherein each confidence map includes a plurality of confidence values in a plurality of positions, each confidence value in a respective position indicating a likelihood that an object of a particular class is located in the respective position; determining a maximum value from at least a first value in a first position of a first confidence map and a second value in a first position of a second confidence map; and generating a combined confidence map for the plurality of confidence maps at least in part by including the maximum value in a first position of the combined confidence map.

In another illustrative example, a non-transitory computer-readable storage medium is provided comprising instructions stored thereon which, when executed by at least one processor, cause the at least one processor to: obtain a plurality of confidence maps associated with different classes of objects, each different confidence map of the plurality of confidence maps being associated with a different class of object, wherein each confidence map includes a plurality of confidence values in a plurality of positions, each confidence value in a respective position indicating a likelihood that an object of a particular class is located in the respective position; determine a maximum value from at least a first value in a first position of a first confidence map and a second value in a first position of a second confidence map; and generate a combined confidence map for the plurality of confidence maps at least in part by including the maximum value in a first position of the combined confidence map.

In another illustrative example, an apparatus is provided for processing one or more confidence maps. The apparatus includes: means for obtaining a plurality of confidence maps associated with different classes of objects, each different confidence map of the plurality of confidence maps being associated with a different class of object, wherein each confidence map includes a plurality of confidence values in a plurality of positions, each confidence value in a respective position indicating a likelihood that an object of a particular class is located in the respective position; means for determining a maximum value from at least a first value in a first position of a first confidence map and a second value in a first position of a second confidence map; and means for generating a combined confidence map for the plurality of confidence maps at least in part by including the maximum value in a first position of the combined confidence map.

In another illustrative example, an apparatus is provided for processing one or more confidence maps. The apparatus includes at least one memory and at least one processor coupled to the at least one memory and configured to: obtain a confidence map associated with a class of object, the confidence map including a plurality of confidence values in a plurality of positions, each confidence value in a respective position of the confidence map indicating a likelihood that an object of the class is located in the respective position; determine a number of rows of confidence values and a number of columns of confidence values in the confidence map including maximum confidence values; and reduce, based on the number of rows and the number of columns in the confidence map including maximum confidence values, a size of the confidence map to generate a reduced-size confidence map.

In another illustrative example, a method for processing one or more confidence maps is provided. The method includes: obtaining a confidence map associated with a class of object, the confidence map including a plurality of confidence values in a plurality of positions, each confidence value in a respective position of the confidence map indicating a likelihood that an object of the class is located in the respective position; determining a number of rows of confidence values and a number of columns of confidence values in the confidence map including maximum confidence values; and reducing, based on the number of rows and the number of columns in the confidence map including maximum confidence values, a size of the confidence map to generate a reduced-size confidence map.

In another illustrative example, a non-transitory computer-readable storage medium is provided comprising instructions stored thereon which, when executed by at least one processor, cause the at least one processor to: obtain a confidence map associated with a class of object, the confidence map including a plurality of confidence values in a plurality of positions, each confidence value in a respective position of the confidence map indicating a likelihood that an object of the class is located in the respective position; determine a number of rows of confidence values and a number of columns of confidence values in the confidence map including maximum confidence values; and reduce, based on the number of rows and the number of columns in the confidence map including maximum confidence values, a size of the confidence map to generate a reduced-size confidence map.

In another illustrative example, an apparatus is provided for processing one or more confidence maps. The apparatus includes: means for obtaining a confidence map associated with a class of object, the confidence map including a plurality of confidence values in a plurality of positions, each confidence value in a respective position of the confidence map indicating a likelihood that an object of the class is located in the respective position; means for determining a number of rows of confidence values and a number of columns of confidence values in the confidence map including maximum confidence values; and means for reducing, based on the number of rows and the number of columns in the confidence map including maximum confidence values, a size of the confidence map to generate a reduced-size confidence map.

In some aspects, one or more of apparatuses described herein include a mobile device (e.g., a mobile telephone or so-called “smart phone” or other mobile device), a wireless communication device, a vehicle or a computing device, system, or component of the vehicle, an extended reality device (e.g., a virtual reality (VR) device, an augmented reality (AR) device, or a mixed reality (MR) device), a wearable device, a personal computer, a laptop computer, a server computer, a camera, or other device. In some aspects, the one or more processors include an image signal processor (ISP). In some aspects, the apparatus includes a camera or multiple cameras for capturing one or more images. In some aspects, the apparatus includes an image sensor that captures the image data. In some aspects, the apparatus further includes a display for displaying the image, one or more notifications (e.g., associated with processing of the image), and/or other displayable data.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example implementation of a system-on-a-chip (SoC), in accordance with some aspects;

FIG. 2A is a diagram illustrating an example of a fully connected neural network, in accordance with some aspects;

FIG. 2B is a diagram illustrating an example of a locally connected neural network, in accordance with some aspects;

FIG. 2C is a diagram illustrating an example of a convolutional neural network, in accordance with some aspects;

FIG. 3 includes illustrative examples of heatmaps, in accordance with some aspects;

FIG. 4 is a diagram illustrating an example of post-processing performed on a heatmap, in accordance with some aspects;

FIG. 5A and FIG. 5B are a diagram illustrating examples of reducing a size of a group of heatmaps by reducing a number of channels of the heatmaps, in accordance with some aspects;

FIG. 6 is a diagram illustrating an example of the system reducing a size of a heatmap by reducing the spatial size of the heatmap, in accordance with some aspects;

FIG. 7A and FIG. 7B are diagrams illustrating examples of heatmaps having a reduced spatial size or dimension, in accordance with some aspects;

FIG. 8A is a flow diagram illustrating an example process for processing one or more confidence maps (or heatmaps), in accordance with aspects of the present disclosure;

FIG. 8B is a flow diagram illustrating another example process for processing one or more confidence maps (or heatmaps), in accordance with aspects of the present disclosure;

FIG. 9 is a block diagram illustrating an example of a deep learning network, in accordance with some examples;

FIG. 10 is a block diagram illustrating an example of a convolutional neural network, in accordance with some examples; and

FIG. 11 is a diagram illustrating an example system architecture for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of aspects and examples of the disclosure. However, it will be apparent that various aspects and examples may be practiced without these specific details. The figures and description are not intended to be restrictive.

The ensuing description provides exemplary aspects and examples only, and is not intended to limit the scope, applicability, or configuration of the disclosure. Rather, the ensuing description of the exemplary aspects and examples will provide those skilled in the art with an enabling description for implementing aspects and examples of the disclosure. It should be understood that various changes may be made in the function and arrangement of elements without departing from the scope of the application as set forth in the appended claims.

As previously described, object detection can be used to identify one or more objects in one or more images (e.g., from a digital image or a video frame of a video clip) or sensor data (e.g., radar or Light Detection and Ranging (LIDAR) data). Object tracking can also be performed in some cases to track the object(s) over time (e.g., over a number of frames). Object detection and/or tracking can be used in different fields, including transportation, video analytics, security systems, robotics, aviation, among others. In some fields, a tracking object (e.g., a tracking vehicle which can also be referred to as an ego vehicle, an extended reality (XR) device, etc.) can determine positions of other objects (e.g., target objects) in an environment so that the tracking object can accurately perform operations with respect to the environment (e.g., navigate through the environment, display virtual content relative to the environment, etc.).

Object detection systems and methods can be used to identify regions (e.g., in one or more images, radar data, LIDAR data, etc.) that correspond to a location of an object. Regions identified by an object detection system may be represented as a bounding region (e.g., a bounding box or another region) that fits around a perimeter of a detected object such as a vehicle. In some cases, a bounding region from the object detection system can be used by another component or system to perform a function based on a position of that bounding region. For example, a bounding region may be input into a vehicle blind spot detector to identify the presence of an object in a blind spot that the vehicle operator is unable to safely perceive.

Machine learning systems (e.g., deep neural network systems or models) can be used to perform a variety of tasks such as, for example and without limitation, detection and/or recognition (e.g., scene or object detection and/or recognition, face detection and/or recognition, etc.), depth estimation, pose estimation, image reconstruction, classification, three-dimensional (3D) modeling, dense regression tasks, data compression and/or decompression, and image processing, among other tasks. Moreover, machine learning models can be versatile and can achieve high quality results in a variety of tasks. For instance, in some cases, a machine learning system can be used to perform object detection, for example, by processing one or more images and detecting one or more objects in the image(s).

In some cases, an output of the machine learning system (e.g., the neural network model) trained to perform object detection can include one or more heatmaps (also referred to herein as confidence maps). For instance, a neural network model can process sensor data (e.g., LIDAR data captured using one or more LIDAR sensors, radar data captured using one or more radar sensors, an image captured using one or more image sensors or cameras) of a scene to generate a heatmap for the scene. A heatmap can be a two-dimensional map (having a width (W) and a height (H)) of values. Each value in the heatmap can represent a score or confidence (as determined by the machine learning system) that an object of a particular class (or category) is present at a corresponding spatial position or location in the heatmap. In some cases, the shape or dimension of the heatmaps output by the machine learning system based on an input (e.g., a LIDAR input, a radar input, an image input, etc.) is [C, H, W], where C is the number of classes (e.g., in a channel or depth dimension), H is the height of each heatmap, and W is the width of each heatmap. The classes can include any class or type of object, such as a vehicle, a pedestrian, a building, an obstacle (e.g., a traffic cone), a street sign, a traffic light, etc. In some cases, a heatmap can have a birds-eye view (BEV) perspective (e.g., an overhead perspective) relative to a tracking object (e.g., a tracking or ego vehicle). A heatmap can also be referred to as a confidence map or a score map.

As noted above, in object detection, a location of an object can be defined or described by a bounding region, such as a bounding box, a bounding ellipse, a bounding square, or other bounding region. A bounding box will be used herein as an illustrative example of a bounding region. In some examples, to generate a bounding box, a system may include a bounding box encoding engine (e.g., a bounding box encoding engine). For instance, the bounding box encoding engine can perform a post-processing step on one or more outputs of a machine learning system (e.g., a neural network model).

In some cases, the bounding box encoding engine can select center positions of detected objects (e.g., detected using an object detection machine learning system) with the K highest scores in a heatmap, where K is equal to or greater than 1. In some cases, the bounding box encoding engine can use a topK operation to select the center positions with the K highest scores. As noted above, the shape or dimension of heatmaps output by the machine learning system can be [C, H, W], in which case the heatmaps include a large number of elements. The number of the K highest scores is typically much smaller than the number of the elements in the heatmaps, resulting in the topK operation, which is O(n), being inefficient.

Systems, apparatuses, processes (also referred to as methods), and computer-readable media (collectively referred to as “systems and techniques”) are described herein for reducing sizes of heatmaps (or confidence maps) output by a machine learning system (e.g., a neural network model) for object detection. For example, the systems and techniques can reduce sizes of the heatmaps by reducing a number of channels of the heatmaps and/or by reducing a spatial resolution of one or more heatmaps.

In some aspects, the systems and techniques can reduce a size of the heatmaps output by the machine learning system by reducing a number of channels of the heatmaps. For example, as noted above, the shape or dimension of the heatmaps output by the machine learning system based on an input (e.g., a LIDAR input, a radar input, an image input, etc.) is [C, H, W]. The number of classes C (also referred to as categories) indicates the number of heatmaps that are output, where one heatmap is output for each class. In general, multiple objects are rarely present at a same spatial position in a scene (e.g., a vehicle is typically not present at the same location as a pedestrian). Thus, given a set of heatmaps with a size of [C, H, W], the systems and techniques can determine maximum values along the class (C) dimension. The systems and techniques can generate a combined heatmap (e.g., a single combined heatmap having a reduced size of [1, H, W]) that includes the maximum values determined along the class (C) dimension. The combined heatmap can include a maximum value from the class dimension at each spatial position in the combined heatmap having a size of [1×H×W]. In one illustrative example, a set of heatmaps output by the machine learning system can have a size of [5, 10, 10], with five classes and thus five heatmaps (including one heatmap per class), a height of ten (corresponding to ten rows), and a width of ten (corresponding to ten columns). Each heatmap will include a value at each intersection of a row and a column of each heatmap (referred to as a “position” or “spatial position” within the heatmap), with a total of 100 values. After reducing the number of channels by determining maximum values along the class dimension, a resulting combined heatmap will have a single value at each position (at an intersection of a column and a row) of the heatmap, with a total of 100 values. Each value will be a maximum value from each corresponding position from the five heatmaps (e.g., a maximum value is selected from the values included in the top-left-most positions in the five heatmaps and included in the top-left-most position of the combined heatmap).

Additionally or alternatively, in some aspects, the systems and techniques can reduce a size of a heatmap by reducing the spatial size of the heatmap (or reduce the size of multiple heatmaps by reducing the spatial size of each heatmap of the multiple heatmaps). In some cases, the systems and techniques can reduce a spatial size of the combined heatmap described above. For instance, the systems and techniques can filter out rows and columns from a heatmap that contain low scores, which can reduce the spatial size of the heatmap. In one illustrative example, by filtering out (or removing) rows and columns from a heatmap, a heatmap having an original size of [1, H, W] can be reduced to a size of [1, H_{f}, W_{f}](H_{f}<<H, W_{f}<<W). Such a solution can be performed without reduction in quality, as high scores in a heatmap are generally sparse.

As described herein, such a solution can preserve high scores in the heatmap, while removing low scores in the heatmap. Reducing sizes of heatmaps results in a decrease in the execution time of object detection (e.g., execution time of Topk operations), while leading to little to no drop in performance.

Various aspects of the present disclosure will be described with respect to the figures.

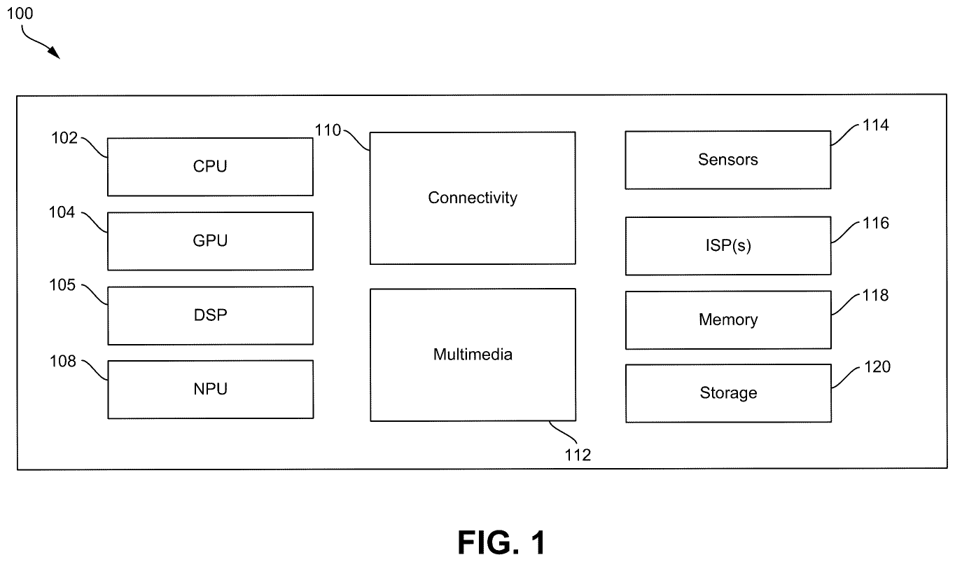

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 105, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 105, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 105, and/or GPU 104. The SOC 100 may also include one or more sensors 114, image signal processors (ISPs) 116, and/or storage 120.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof may be configured to perform image processing using machine learning techniques according to aspects of the present disclosure discussed herein. For example, SOC 100 and/or components thereof may be configured to perform disparity estimation refinement for pairs of images (e.g., stereo image pairs, each including a left image and a right image). SOC 100 can be part of a computing device or multiple computing devices. In some examples, SOC 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 105, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 105, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 105, the NPU 108, the connectivity block 110, the multimedia processor 112, the one or more sensors 114, the ISPs 116, the memory block 118 and/or the storage 120 can be part of two or more separate computing devices.

Machine learning (ML) can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

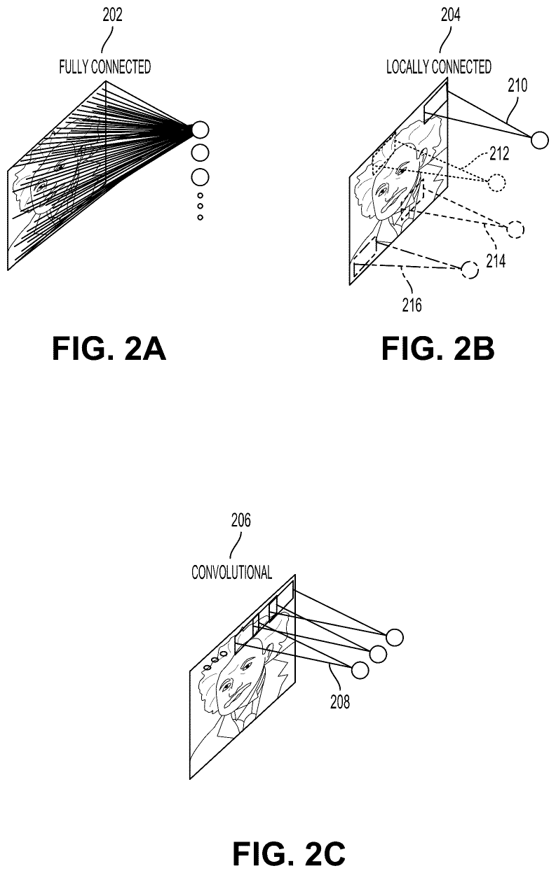

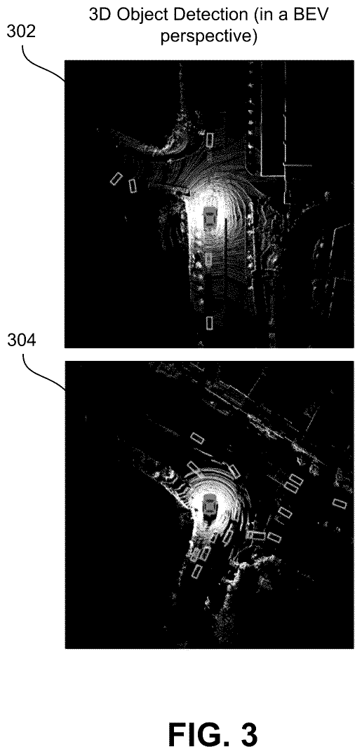

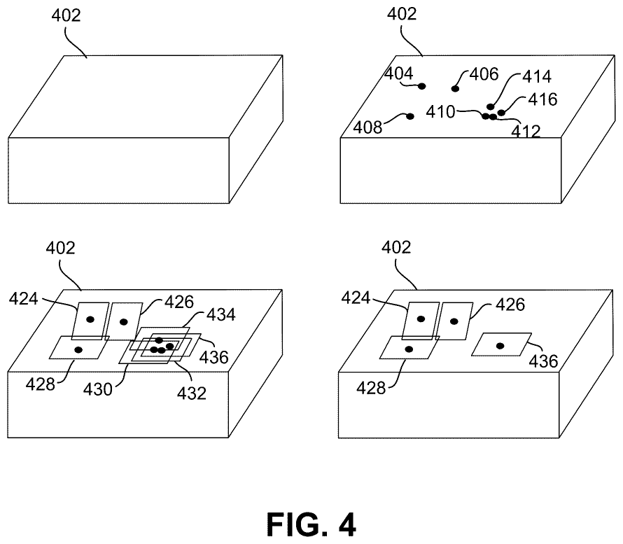

The connections between layers of a neural network may be fully connected or locally connected. FIG. 2A illustrates an example of a fully connected neural network 202. In a fully connected neural network 202, a neuron in a first hidden layer may communicate its output to every neuron in a second hidden layer, so that each neuron in the second layer will receive input from every neuron in the first layer. FIG. 2B illustrates an example of a locally connected neural network 204. In a locally connected neural network 204, a neuron in a first hidden layer may be connected to a limited number of neurons in a second hidden layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

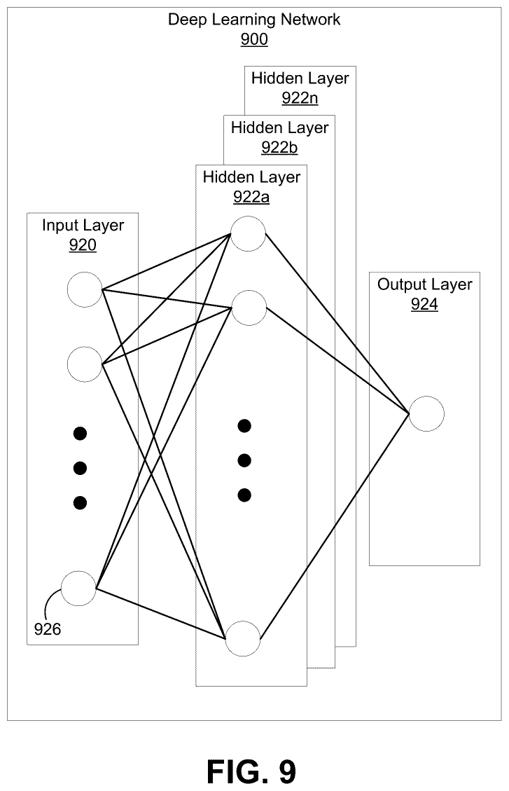

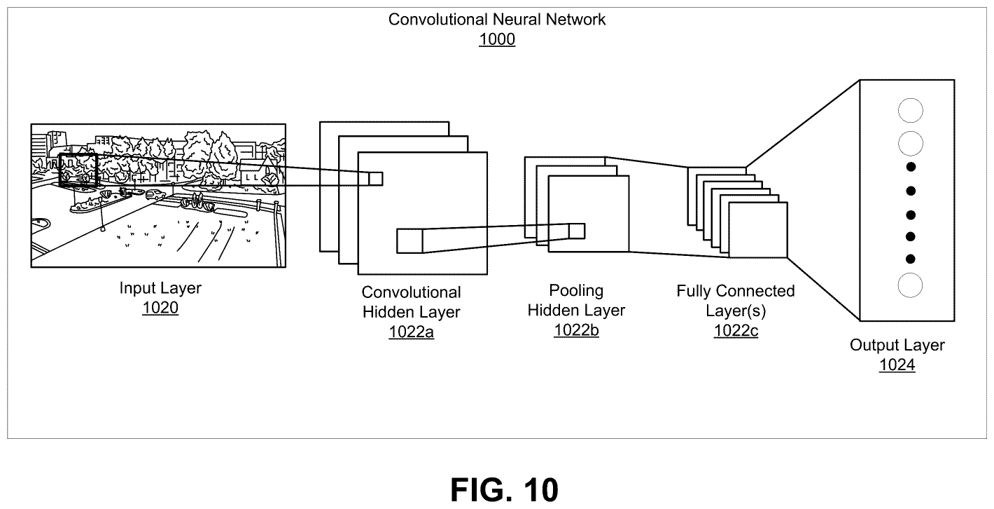

An example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. Convolutional neural network 206 may be used to perform one or more aspects of video compression and/or decompression, according to aspects of the present disclosure. An illustrative example of a deep learning network is described in greater depth with respect to the example block diagram of FIG. 9. An illustrative example of a convolutional neural network is described in greater depth with respect to the example block diagram of FIG. 10.

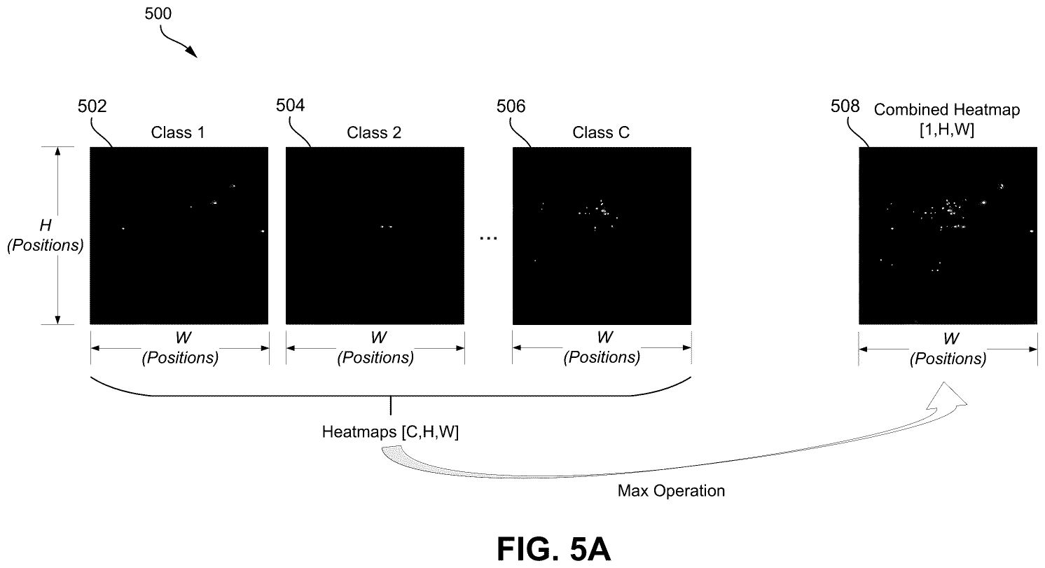

As mentioned previously, a machine learning system (e.g., a deep neural network system or model, such as that described with respect to FIG. 2A-3C, FIG. 9, and/or FIG. 10) can be used to perform object detection, for example, by processing one or more images and detecting one or more objects in the image(s). A machine learning system trained to perform object detection can be referred to herein as an object detection machine learning system or model. In some cases, an output of an object detection machine learning system (e.g., an object detection neural network model) can include one or more heatmaps. For instance, an object detection neural network model can process sensor data of a scene to generate a heatmap for the scene. The sensor data can include Light Detection and Ranging (LIDAR) data captured using one or more LIDAR sensors, radar data captured using one or more radar sensors, an image captured using one or more image sensors or cameras, any combination thereof, and/or other sensor data.

A heatmap can be a two-dimensional map of values. Each value in the heatmap can represent a score or confidence (as determined by the machine learning system) that an object of a particular class is present at a corresponding spatial position or location in the heatmap. In some cases, the shape or dimension of the heatmaps output by the machine learning system is [C, H, W], where C is the number of classes (e.g., in a channel or depth dimension), H is the height of each heatmap, and W is the width of each heatmap. The classes can include any class or type of object, such as a vehicle, a pedestrian, a building, an obstacle (e.g., a traffic cone), a street sign, a traffic light, etc. In some cases, a heatmap can have a birds-eye view (BEV) perspective (e.g., an overhead perspective) relative to a tracking object (e.g., a tracking or ego vehicle).

FIG. 3 includes illustrative examples of two heatmaps generated based on LIDAR data, including a heatmap 302 representing a scene a first point in time (e.g., generated using LIDAR data captured at the first point in time) and a heatmap 304 representing a scene at a second point in time (e.g., generated using LIDAR data captured at the first point in time). As shown, a tracking vehicle (or ego vehicle) is positioned in the center of each heatmap 302, and various bounding boxes representing locations of one or more classes of objects (e.g., other vehicles, pedestrians, etc.) are shown in the scene as surrounding the tracking vehicle.

In object detection, a location of an object can be defined or described by a bounding box or other bounding region (e.g., a bounding ellipse, a bounding square, etc.). A bounding box will be used herein as an illustrative example of a bounding region. In some cases, a bounding box can be defined or represented as a center position (e.g., with a horizontal or x-coordinate and a vertical or -y coordinate, denoted as (x,y)), height, and width.

In some aspects, to generate a bounding box, a system may include a bounding box encoding engine (e.g., a bounding box encoding engine). For instance, the bounding box encoding engine can perform a post-processing step on one or more outputs of an object detection machine learning system (e.g., an object detection neural network model). In some cases, the bounding box encoding engine can select center positions with the K highest scores in a heatmap, where K is equal to or greater than 1. In some cases, the bounding box encoding engine can use a topK operation to select the center positions with the K highest scores.

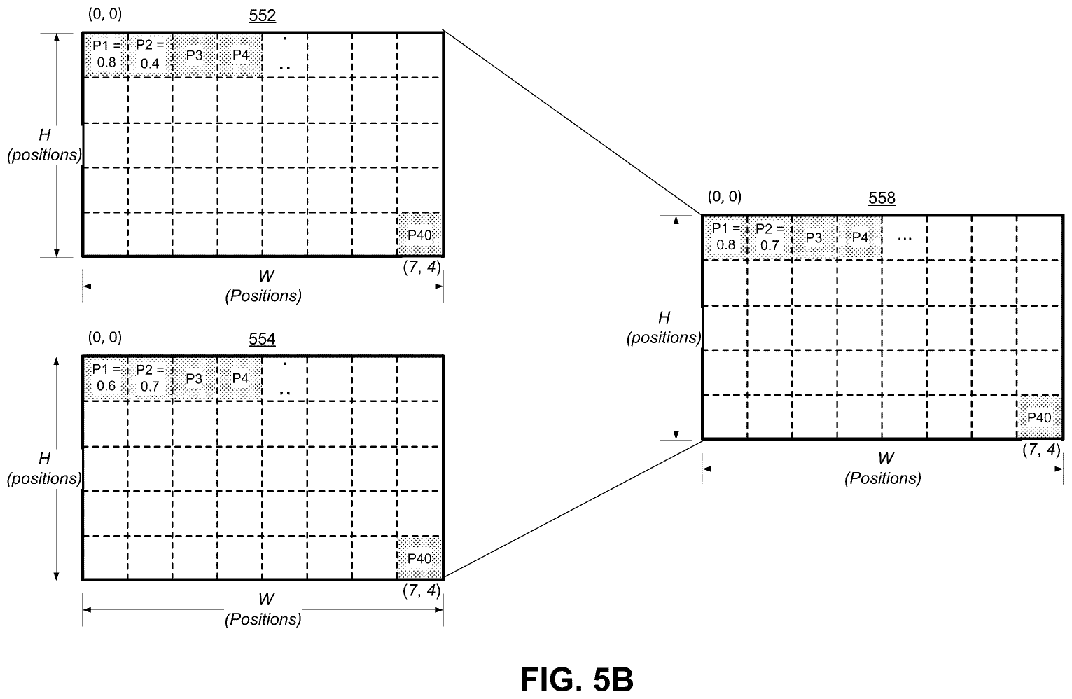

FIG. 4 is a diagram illustrating an example of post-processing performed on a heatmap by a bounding box encoding engine. As illustrated in FIG. 4, a class-wise heatmap 402 (having a size of [C, H, W]) is output from an object detection machine learning system (e.g., an object detection neural network model). The bounding box encoding engine can then find positions in the heatmap 402 where objects might exist, such as by performing a topK operation to select the K highest scores. The K highest scores in the example of FIG. 4 correspond to points 404, 406, 408, 410, 412, 414, and 416, in which case K is equal to 7.

The bounding box encoding engine can assign K bounding boxes to the K points. In the example of FIG. 4, K=7, in which case the bounding box encoding engine can assign the K bounding boxes 424, 426, 428, 430, 432, 434, and 436 to the K points 404-416. For instance, the bounding box encoding engine can regress the K boxes using predicted box attributes (also referred to as box attributions). In some aspects, the predicted box attributes can be output by the object detection machine learning system along with one or more heatmaps (e.g., heatmap 402). In some cases, the predicted box attributes can include a width and height of each bounding box associated with a respective point (e.g., a width and height of the bounding box 424 associated with point 404, a width and height of the bounding box 426 associated with point 406, and so on), a rotation angle of each bounding box, an index value associated with a point and corresponding bounding box (e.g., an index value associated with point 408 and corresponding bounding box 428).

The bounding box encoding engine can then determine or select a single most confident bounding box (e.g., with the highest confidence score) from any overlapping bounding boxes to include in an object detection output. In one illustrative example, the bounding box encoding engine can perform Non-Maximum Suppression (NMS) to select a single bounding box from the overlapping bounding boxes. For example, as shown in FIG. 4, the bounding boxes 430, 432, 434, and 436 are overlapping with one another, while the bounding boxes 424, 426, and 428 are not overlapping. The bounding box encoding engine can select (e.g., based on performing NMS) the bounding box 436 (e.g., the confidence score of the bounding box 436 is higher than that of the bounding boxes 430, 432 and 434) from the overlapping bounding boxes to include in an object detection output.

The NMS operation can operate using a set of bounding box proposals (denoted as BB_{P}), a confidence score for each bounding box (denoted as S_{BB}), and overlap threshold (denoted as O_{Th}) as input, and can output a final set of bounding boxes (BB_{F}). For example, using the NMS operation, the bounding box encoding engine can select the proposal with the highest confidence score (denoted as BB₁), remove it from the proposals BB_{P}, and add it to the final set of bounding boxes BB_{F}. The bounding box encoding engine can then compare the proposal bounding box BB₁ with all of the bounding box proposals, such as by calculating the intersection-over-union (IoU) of the proposal BB₁ with every other proposal. If the IoU is greater than the threshold O_{T}h, the proposal BB₁ can be removed from the set of proposals BB_{P}. The bounding box encoding engine can then take the proposal in the updated set of proposals BB_{P} with the highest confidence (denoted to as BB₂) and remove the proposal BB₂ from BB_{P} and add the proposal BB₂ to BB_{F}. The bounding box encoding engine can calculate the IoU of the proposal BB₂ with all the proposals in BB_{P} and eliminate the boxes which have an IoU greater than the threshold O_{T}h. This NMS operation can be repeated until there are no longer any proposals left in BB_{P}.

As noted above, the shape or dimension of heatmaps output by the machine learning system can be [C, H, W], in which case the heatmaps include a large number of elements. The number of the K highest scores is typically much smaller than the number of the elements in the heatmaps, resulting in the topK operation, which is O(n), being inefficient. For example, a heatmap from a Bevfusion neural network model with a Centerpoint Head has a size of [C, 180, 180] and the topK operation finds 500(=K) highest scores from 32400*C elements. Even with C=1, only 500/32400=1.5% elements are selected by the topK operation.

As noted previously, systems and techniques are described herein for reducing sizes of heatmaps (or confidence maps) output by a machine learning system (e.g., a neural network model) for object detection. For example, as described herein, the systems and techniques can reduce sizes of the heatmaps by reducing a number of channels of the heatmaps and/or by reducing a spatial resolution of one or more heatmaps. A heatmap is also referred to herein as a confidence map. In some cases, the techniques can be performed by a system, such as a bounding box encoding engine (e.g., as a post-processing step on one or more heatmaps). The reduced-size heatmap can then be processed using an operation, such as a topK operation, to determine bounding boxes to output for object detection. Reducing the sizes of the heatmaps can preserve high confidence scores in the heatmap, while removing low confidence scores in the heatmap and thus decreasing the execution time of object detection (e.g., execution time of Topk operations) and resulting in little to no drop in performance.

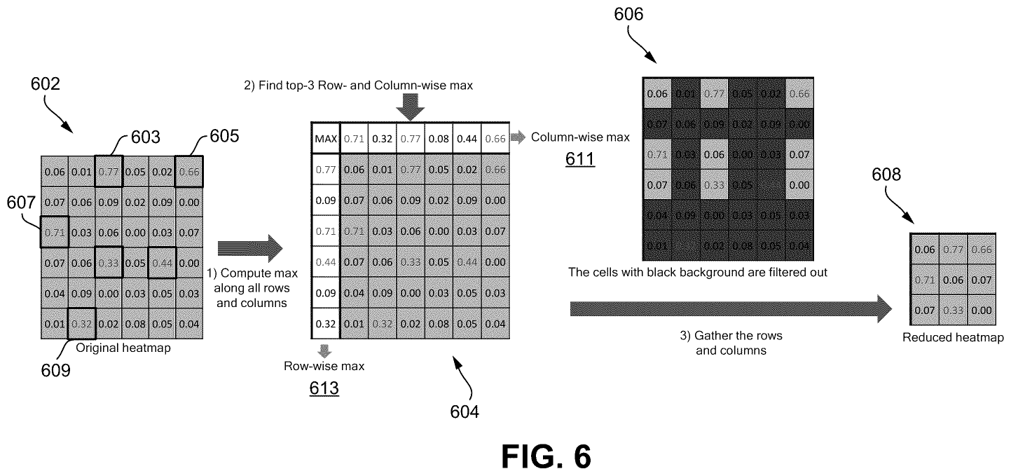

FIG. 5A is a diagram 500 illustrating an example of the system reducing a size of a group of heatmaps 502, 504, through 506 output by object detection machine learning system (e.g., an object detection neural network model) by reducing a number of channels of the heatmaps 502, 504, though 506. As shown, the shape or dimension of the group of heatmaps 502, 504, and 506 is [C, H, W], where C is the number of classes C (in a channel dimension), H corresponds to a height of each heatmap, and W corresponds to a width of each heatmap. In some cases, one heatmap is output for each class C, in which case the class C corresponds to the number of heatmaps output by the object detection machine learning system for a given input (e.g., based on input LIDAR data, radar data, an image, etc.).

The number of classes C can include any suitable number, such as three, five, ten, fifty, or other number. For example, the heatmap 502 corresponds to a first class (shown as class 1), the heatmap 504 corresponds to a second class (shown as class 2), and the heatmap 506 corresponds to a third class (shown as class C). In one illustrative example, the first class can correspond to a car class, the second class can correspond to a truck class, and the third class can correspond to a pedestrian class.

Multiple objects are rarely present at a same spatial position in a scene (e.g., a car is typically not present at the same location as a truck or pedestrian). Further, due to the NMS operation, only one box with the highest score is selected among many highly overlapped boxes. Thus, it is possible to use one value for each given point or position (with center position (x,y), such as point 416 in FIG. 4) among the group of heatmaps 502, 504, 506 in one combined heatmap 508 (corresponding to one channel), so that the combined heatmap 508 includes the highest scores. The system can thus perform a max operation to determine the highest scores from among the group of heatmaps 502, 504, and 506. The system can include the highest scores in the combined heatmap 508. For instance, one value for each position in the group of heatmaps can be determined and include in the combined heatmap 508.

In one illustrative example, given the group of heatmaps 502, 504, through 506 (with a size of [C, H, W], as noted above), the system can determine a maximum value from the heatmaps 502, 504, through 506 along the class (C) dimension for each corresponding position of the heatmaps 502, 504, through 506. The system can include the maximum values determined along the class (C) dimension in the combined heatmap 508. The combined heatmap 508 can thus include a maximum value from the heatmaps 502, 504, through 506 along the class (C) dimension at each spatial position of the combined heatmap 508. Based on selecting a maximum value from the heatmaps 502, 504, through 506 along the class (C) dimension, the combined heatmap 508 includes a single combined heatmap having a reduced size of [1, H, W].

An example of applying the max operation along the class or category (e.g., channel) dimension of the group of heatmaps 502, 504, though 506 is as follows:

$$\tilde{h} ( x , y ) = {max}_{c} h ( c , x , y ) for 0 \leq x < W , 0 \leq y < H , 0 \leq c < C ,$$

where, as noted previously, W is the width of each heatmap, H is the height of the heatmap, and C is the number of classes or categories. Such an operation can yield 1/C elements as compared with the original heatmap and maintains all highest scores into a single channel or heatmap.

FIG. 5B is a diagram illustrating an illustrative example of reducing a number of channels of heatmaps 552 and 554 (corresponding to two classes) to a single combined heatmap 558. The heatmap 552 corresponds to a first class (e.g., a car class) and the second heatmap 554 corresponds to a second class (e.g., a pedestrian class). Each of the heatmaps 552 and 554 includes a spatial size of [5, 8](corresponding to [H, W]), in which case the heatmaps 552, 554 include a total size of [2, 5, 8](corresponding to [C, H, W).

As shown, the heatmap 552 and the heatmap 554 each have a number of positions, with one position occurring at an intersection of a row and a column of each heatmap. Each position denoted in FIG. 5B as P1, P2, P3, P4, through P40. The position P1 is at spatial coordinate (0, 0) (at an intersection of the first row and the first column) within each heatmap 552, 554, the position P2 is at spatial coordinate (0, 1) within each heatmap 552, 554, and so on. The heatmaps 552, 554 include a confidence value (or score) at each position. For example, the heatmap 552 includes a confidence value of 0.8 at the first position (P1) and a confidence value of 0.4 at the first position (P2). As shown, the heatmap 554 includes a confidence value of 0.6 at the first position (P1) and a confidence value of 0.7 at the first position (P2). While not shown in FIG. 5B, the other positions P3 through P40 will also include confidence values.

As noted above, the system can determine a maximum value from the heatmaps 552 and 554 along the class (C) dimension for each corresponding position of the heatmaps 552 and 554 and can include the maximum value from each position in the combined heatmap 558. For example, the system can determine that the maximum value at the first position (P1) from the heatmaps 552 and 554 is 0.8 (e.g., max(0.8, 0.6)), which corresponds to the confidence value of 0.8 included at position P1 of the heatmap 552. The system can then include the confidence value of 0.8 in the first position (P1) of the combined heatmap 558. Similarly, the system can determine that the maximum value at the second position (P2) from the heatmaps 552 and 554 is 0.7 (e.g., max(0.4, 0.7)), corresponding to the confidence value of 0.7 included at position P1 of the heatmap 554. The system can add the confidence value of 0.7 to the second position (P2) of the combined heatmap 558. Similar operations can be performed for positions P3 through P40 of the heatmaps 552 and 554 to determine maximum values to add to the combined heatmap 558. After reducing the number of channels by determining maximum values along the class dimension, the resulting combined heatmap 558 will have a single confidence value at each position of the combined heatmap 558.

As noted previously, in some cases, the system can reduce the size of a heatmap by reducing the spatial size of the heatmap. For instance, rather than inputting a full-size heatmap into a TopK operation, the system can reduce the size of the heatmap by removing low scores prior to performing the TopK operation. In some aspects, given a heatmap that includes a number of valid confidence values (or scores) that are greater than a confidence score threshold, the system can determine (e.g., compute) max scores along all rows and columns. The system can determine the top H_{f} and W_{f} values from a row-wise max and a column-wise max (e.g., H_{f}=3 and W_{f}=3). The system can obtain the rows and columns where the top-H_{f} and top-W_{f} max values are located, and can include them in a reduced heatmap. H_{f} and W_{f} can determine the final heatmap size as [H_{f}, W_{f}]. The smaller H_{f} and W_{f} can decrease the execution time of the post-processing steps.

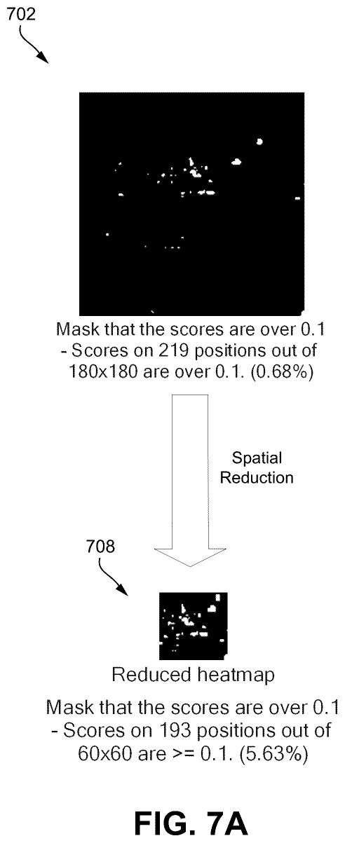

FIG. 6 is a diagram illustrating an example of the system reducing a size of a heatmap 602 by reducing the spatial size of the heatmap 602. For example, as shown in FIG. 6, a small number of positions within the heatmap 602 include high confidence values (e.g., values greater than the confidence score threshold). The confidence score threshold can be set to any suitable value, such as 0.1, 0.2, or other suitable value. In the example of FIG. 6, and using a confidence score threshold of 0.1 for illustrative purposes, six of the confidence values from the heatmap 602 are greater than a confidence score threshold of 0.1. The positions in the heatmap 602 the confidence values greater than the confidence score threshold are bolded (e.g., position 603, position 605, position 607, position 609, etc.).

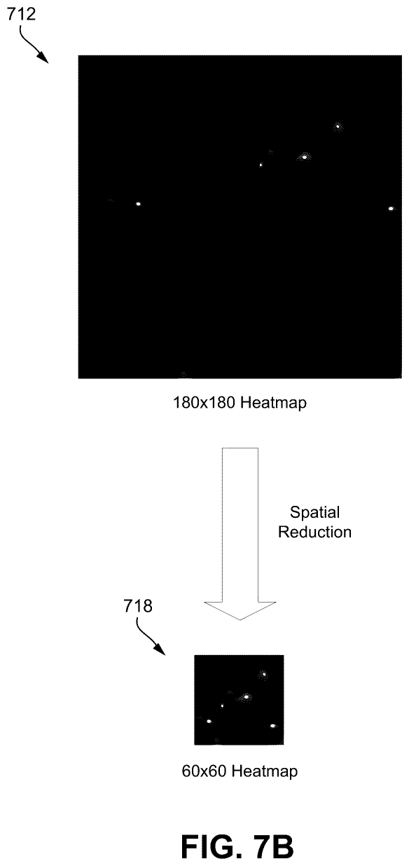

FIG. 7A and FIG. 7B are diagrams illustrating examples of heatmaps being reduced in size. For example, in FIG. 7A, a spatial size of a heatmap 702 is reduced to generate a reduced heatmap 708. Similarly, in FIG. 7B, a spatial size of a heatmap 712 is reduced to generate a reduced heatmap 718. In the example of FIG. 7A, the heatmap 702 contains only 0.68% (219 out of 180×180=32,400 positions) valid confidence values or scores that are not smaller than a confidence score threshold of 0.1. Rather than inputting the heatmap 702 into a TopK operation, the system can reduce the size of the heatmap 702 by removing low scores ahead of the TopK operation using the techniques described herein. In one illustrative example, the original heatmap 702 can be reduced from a size of 180×180 to generate the reduced heatmap 708 having a size of 60×60.

Returning to FIG. 6, the system can determine (e.g., compute) maximum confidence values along all of the rows and columns of the heatmap 602. The system can then find the top-N row-wise max values and the top-N column-wise max values (where N=3 in the example of FIG. 6) within the heatmap 602. For example, FIG. 6 includes a representation 604 of the heatmap 602 that includes a column-wise max row 611 indicating the column-wise max values. The representation 604 of the heatmap 602 also includes a row-wise max column 613 indicating the row-wise max values. As shown in the column-wise max row 611, the top three maximum values from the columns of the heatmap 602 include a value of 0.71 from the first column of the heatmap 602, a value of 0.77 from the third column of the heatmap 602, and a value of 0.66 from the sixth (and last) column of the heatmap 602. As shown in the row-wise max column 613, the top three maximum values from the rows of the heatmap 602 include a value of 0.77 from the first row of the heatmap 602, a value of 0.71 from the third row of the heatmap 602, and a value of 0.44 from the fourth row of the heatmap 602.

The system can then generate a final heatmap 608 (having a reduced spatial size as compared to the original heatmap 602) by filtering out (or removing) the rows and columns from the heatmap 602 that were not included in the top-N rows and the top-N columns, which are the rows and columns that contain low scores. For example, as shown in FIG. 6, a representation 606 of the heatmap 602 illustrates the values from the rows and columns that are filtered out with a dark background, while the values of the top-N rows and the top-N columns (e.g., the top-3 rows and top-3 columns) include a light background. As illustrated by the representation 606, each confidence value that occurs at an intersection of a column-wise max and a row-wise max will be included in the final heatmap 608. As a result, the final heatmap 608 includes only the values from the top-N rows and the top-N columns. In one illustrative example, by filtering out rows and columns from a heatmap, a heatmap having an original size of [1, H, W] can be reduced to a size of [1, H_{f}, W_{f}](H_{f}<<H,W_{f}<<W).

In some cases, the system can reduce the size of multiple heatmaps by reducing the spatial size of each of the heatmaps. In some aspects, the system can reduce a spatial size of a combined heatmap (e.g., the combined heatmap 508, the combined heatmap 558, etc.), resulting in a reduction in the channel size of the heatmap and the spatial resolution of the heatmap. In such cases, the heatmap 602 can include a combined heatmap (e.g., the combined heatmap 508, the combined heatmap 558, etc.).

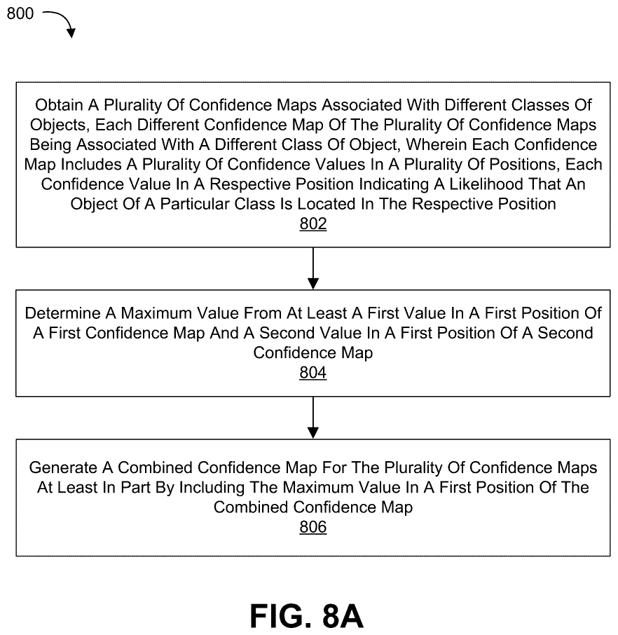

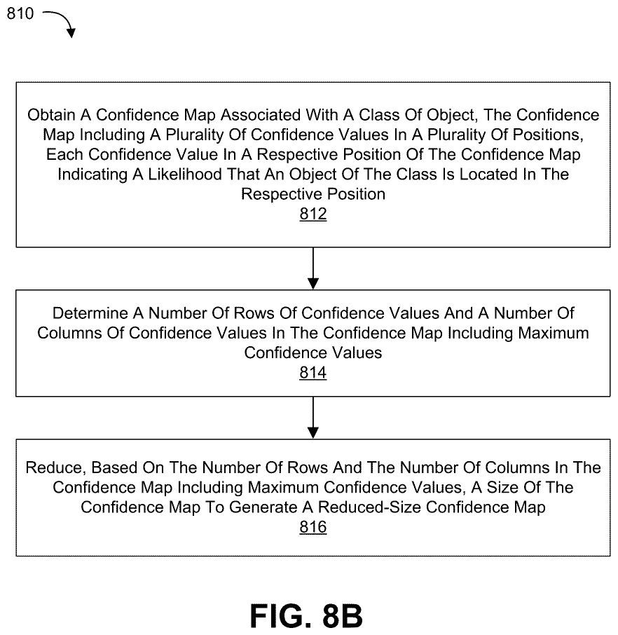

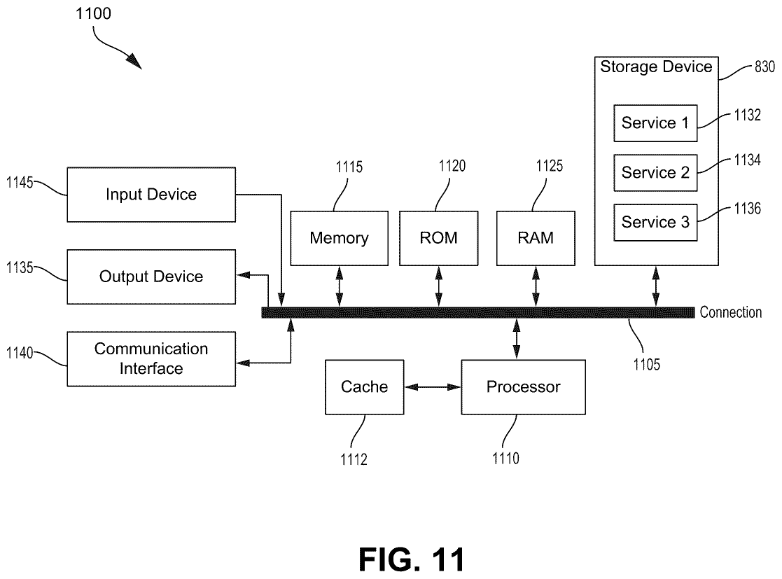

FIG. 8A is a flowchart illustrating an example process 800 for processing one or more confidence maps (or heatmaps), using one or more of the techniques described herein. The process 800 can be performed by a computing device (or apparatus), or a component of a computing device (e.g., a chipset, an SOC such as SOC 100, one or more processors such as CPU(s), GPU(s), NPU(s), DSP(s), etc.), which may utilize or implementing a machine learning model (e.g., a neural network model). The computing device or apparatus may be a vehicle or component or system of a vehicle, a mobile device (e.g., a mobile phone), a network-connected wearable such as a watch, an extended reality (XR) device (e.g., a virtual reality (VR) device, augmented reality (AR) device, and/or mixed reality (MR) device), or other type of computing device. In some cases, the computing device or apparatus can be the SOC 100 of FIG. 1, the computing system 1100 of FIG. 11, and/or other computing device or apparatus.

At block 802, the computing device (or component thereof) can obtain a plurality of confidence maps associated with different classes of objects. Each different confidence map of the plurality of confidence maps is associated with a different class of object (e.g., a “car” object, a “pedestrian” object, etc.). Each confidence map includes a plurality of confidence values in a plurality of positions, with each confidence value in a respective position indicating a likelihood that an object of a particular class is located in the respective position. For example, the position P1 in the heatmap 552 (also referred to as a confidence map) of FIG. 5B includes a confidence value of 0.8 (e.g., indicating an 80% chance that a “car” object is located in the position P1) and the position P2 in the heatmap 552 of FIG. 5B includes a confidence value of 0.4 (e.g., indicating a 40% chance that a “car” object is located in the position P2). In another example, the position P1 in the heatmap 554 of FIG. 5B includes a confidence value of 0.6 (e.g., indicating an 80% chance that a “pedestrian” object is located in the position P1) and the position P2 in the heatmap 554 of FIG. 5B includes a confidence value of 0.7 (e.g., indicating a 70% chance that a “pedestrian” object is located in the position P2). In some cases, the plurality of confidence maps is output by a machine learning model (e.g., an object detection machine learning model, such as the CNN 1000 of FIG. 10).

At block 804, the computing device (or component thereof) can determine a maximum value from at least a first value in a first position of a first confidence map and a second value in a first position of a second confidence map. Referring to FIG. 5B as an illustrative example, the computing device can determine that the maximum value at the position P1 from the heatmaps 552 and 554 is 0.8 (corresponding to the confidence value of 0.8 included at position P1 of the heatmap 552).

At block 806, the computing device (or component thereof) can generate a combined confidence map for the plurality of confidence maps at least in part by including the maximum value in a first position of the combined confidence map. For instance, the computing device (or component thereof) can determine a respective maximum value from each position in the plurality of confidence maps and can include each respective maximum value in each position of the combined confidence map. Referring again to FIG. 5B as an illustrative example, the computing device can add the confidence value of 0.8 in the position P1 of the combined heatmap 558, can add the confidence value of 0.7 to the position P2 of the combined heatmap 558, and so on.

In some aspects, the computing device (or component thereof) can process the combined confidence map to determine a plurality of bounding boxes (e.g., the bounding boxes 424, 426, 428, and 436 of FIG. 4) for the different classes of objects. In some cases, to process the combined confidence map to determine the plurality of bounding boxes for the different classes of objects, the computing device (or component thereof) can determine a particular number of positions (e.g., the points 404 through 416 of FIG. 4) in the combined confidence map having highest confidence scores. The computing device (or component thereof) can determine an initial plurality of bounding boxes (e.g., the bounding boxes 424 through 436 of FIG. 4) for the particular number of positions. The computing device (or component thereof) can filter the initial plurality of bounding boxes to determine the plurality of bounding boxes (e.g., the bounding boxes 424, 426, 428, and 436 of FIG. 4).

In some cases, the computing device (or component thereof) can determine a number of rows of confidence values and a number of columns of confidence values in the combined confidence map including maximum confidence values (e.g., three rows and three columns, such as shown in FIG. 6). The computing device (or component thereof) can reduce, based on the number of rows and the number of columns in the combined confidence map including maximum confidence values, a size of the combined confidence map to generate a reduced-size confidence map (e.g., reduce the heatmap 602 of FIG. 6 having a size of 6×6 to generate the reduced-size heatmap 608 having a size of 3×3). In some cases, the computing device (or component thereof) can process the reduced-size confidence map to determine a plurality of bounding boxes for the different classes of objects. For instance, to process the reduced-size confidence map to determine the plurality of bounding boxes for the different classes of objects, the computing device (or component thereof) can determine a particular number of positions in the reduced-size confidence map having highest confidence scores, determine an initial plurality of bounding boxes for the particular number of positions, and filter the initial plurality of bounding boxes to determine the plurality of bounding boxes, as described previously.

FIG. 8B is a flowchart illustrating an example process 810 for processing one or more confidence maps (or heatmaps), using one or more of the techniques described herein. The process 810 can be performed by a computing device (or apparatus), or a component of a computing device (e.g., a chipset, an SOC such as SOC 100, one or more processors such as CPU(s), GPU(s), NPU(s), DSP(s), etc.), which may utilize or implementing a machine learning model (e.g., a neural network model). The computing device or apparatus may be a vehicle or component or system of a vehicle, a mobile device (e.g., a mobile phone), a network-connected wearable such as a watch, an extended reality (XR) device (e.g., a virtual reality (VR) device, augmented reality (AR) device, and/or mixed reality (MR) device), or other type of computing device. In some cases, the computing device or apparatus can be the SOC 100 of FIG. 1, the computing system 1100 of FIG. 11, and/or other computing device or apparatus.

At block 812, the computing device (or component thereof) can obtain a confidence map associated with a class of object. The confidence map includes a plurality of confidence values in a plurality of positions, with each confidence value in a respective position of the confidence map indicating a likelihood that an object of the class is located in the respective position. For example, the position P1 in the heatmap 552 (also referred to as a confidence map) of FIG. 5B includes a confidence value of 0.8 (e.g., indicating an 80% chance that a “car” object is located in the position P1) and the position P2 in the heatmap 552 of FIG. 5B includes a confidence value of 0.4 (e.g., indicating a 40% chance that a “car” object is located in the position P2). In another example, the position P1 in the heatmap 554 of FIG. 5B includes a confidence value of 0.6 (e.g., indicating an 80% chance that a “pedestrian” object is located in the position P1) and the position P2 in the heatmap 554 of FIG. 5B includes a confidence value of 0.7 (e.g., indicating a 70% chance that a “pedestrian” object is located in the position P2). In some cases, the plurality of confidence maps is output by a machine learning model (e.g., an object detection machine learning model, such as the CNN 1000 of FIG. 10).

At block 814, the computing device (or component thereof) can determine a number of rows of confidence values and a number of columns of confidence values in the confidence map including maximum confidence values. For instance, as described previously, the computing device (or component thereof) can determine the top-N row-wise max values and the top-N column-wise max values (e.g., N=3, such as in the example of FIG. 6) within the confidence map (e.g., within the heatmap 602 of FIG. 6). Referring to FIG. 6 as an illustrative example, the representation 604 of the heatmap 602 (which can also be referred to as a confidence map) includes a column-wise max row 611 indicating the column-wise max values and a row-wise max column 613 indicating the row-wise max values. As shown in the column-wise max row 611, the top three maximum values from the columns of the heatmap 602 include a value of 0.71 from the first column of the heatmap 602, a value of 0.77 from the third column of the heatmap 602, and a value of 0.66 from the sixth (and last) column of the heatmap 602. As shown in the row-wise max column 613, the top three maximum values from the rows of the heatmap 602 include a value of 0.77 from the first row of the heatmap 602, a value of 0.71 from the third row of the heatmap 602, and a value of 0.44 from the fourth row of the heatmap 602.

At block 816, the computing device (or component thereof) can reduce, based on the number of rows and the number of columns in the confidence map including maximum confidence values, a size of the confidence map to generate a reduced-size confidence map. In some cases, to reduce the size of the confidence map based on the number of rows and the number of columns in the confidence map including maximum confidence values, the computing device (or component thereof) can remove at least one row of confidence values and at least one column of confidence values from the confidence map that are not included in the number of rows of confidence values and the number of columns of confidence values in the confidence map including maximum confidence values. The computing device (or component thereof) can maintain, in the confidence map, the number of rows of confidence values and the number of columns of confidence values in the confidence map including maximum confidence values. Referring again to FIG. 6 as an illustrative example, computing device (or component thereof) can generate a final heatmap 608 by filtering out (or removing) the rows and columns from the heatmap 602 that were not included in the top-N rows and the top-N columns. As shown in FIG. 6, each confidence value that occurs at an intersection of a column-wise max and a row-wise max is included in the final heatmap 608.

In some cases, the confidence map is a combined confidence map generated based on a plurality of confidence maps associated with different classes of objects. In some examples, the computing device (or component thereof) can generate the combined confidence map. In some cases, to generate the combined confidence map, the computing device (or component thereof) can obtain the plurality of confidence maps, determine a maximum value from at least a first value in a first position of a first confidence map and a second value in a first position of a second confidence map, and generate the combined confidence map for the plurality of confidence maps at least in part by including the maximum value in a first position of the combined confidence map, as described previously. In some aspects, the computing device (or component thereof) can determine a respective maximum value from each position in the plurality of confidence maps and can include each respective maximum value in each position of the combined confidence map (e.g., as illustrated in FIG. 7B).

As noted above, the processes described herein (e.g., process 800, process 810, and/or any other process described herein) may be performed by a computing device or apparatus utilizing or implementing a machine learning model (e.g., a neural network model). In some examples, the process 800 can be performed by the SOC 100 of FIG. 1. In another example, the process 800 can be performed by the computing system having the computing device architecture of the computing system 1100 shown in FIG. 11. For instance, a computing device with the computing device architecture of the computing system 1100 shown in FIG. 11 can implement the operations of FIG. 8A or FIG. 8B and/or the components and/or operations described herein with respect to any of FIGS. 4 through 8B.

The computing device can include any suitable device, such as a mobile device (e.g., a mobile phone), a desktop computing device, a tablet computing device, an XR device (e.g., a VR headset, an AR headset, AR glasses, etc.), a wearable device (e.g., a network-connected watch or smartwatch, or other wearable device), a server computer, a vehicle (e.g., an autonomous vehicle) or computing device of the vehicle, a robotic device, a laptop computer, a smart television, a camera, and/or any other computing device with the resource capabilities to perform the processes described herein, including the process 800, the process 810, and/or any other process described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 800 and the process 810 are illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 800, process 810, and/or any other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is an illustrative example of a deep learning neural network 900 that can be used to perform object detection. An input layer 920 includes input data. In some examples, the input layer 920 can include data representing the pixels of an input video frame. The neural network 900 includes multiple hidden layers 922a, 922b, through 922n. The hidden layers 922a, 922b, through 922n include “n” number of hidden layers, where “n” is an integer greater than or equal to one. The number of hidden layers can be made to include as many layers as needed for the given application. The neural network 900 further includes an output layer 924 that provides an output resulting from the processing performed by the hidden layers 922a, 922b, through 922n. In some examples, the output layer 924 can provide a classification for an object in an input video frame. The classification can include a class identifying the type of object (e.g., a person, a dog, a cat, or other object).

The neural network 900 is a multi-layer neural network of interconnected nodes. Each node can represent a piece of information. Information associated with the nodes is shared among the different layers and each layer retains information as information is processed. In some cases, the neural network 900 can include a feed-forward network, in which case there are no feedback connections where outputs of the network are fed back into itself. In some cases, the neural network 900 can include a recurrent neural network, which can have loops that allow information to be carried across nodes while reading in input.

Information can be exchanged between nodes through node-to-node interconnections between the various layers. Nodes of the input layer 920 can activate a set of nodes in the first hidden layer 922a. For example, as shown, each of the input nodes of the input layer 920 is connected to each of the nodes of the first hidden layer 922a. The nodes of the hidden layers 922a, 922b, through 922n can transform the information of each input node by applying activation functions to the information. The information derived from the transformation can then be passed to and can activate the nodes of the next hidden layer 922b, which can perform their own designated functions. Example functions include convolutional, up-sampling, data transformation, and/or any other suitable functions. The output of the hidden layer 922b can then activate nodes of the next hidden layer, and so on. The output of the last hidden layer 922n can activate one or more nodes of the output layer 924, at which an output is provided. In some cases, while nodes (e.g., node 926) in the neural network 900 are shown as having multiple output lines, a node has a single output and all lines shown as being output from a node represent the same output value.

In some cases, each node or interconnection between nodes can have a weight that is a set of parameters derived from the training of the neural network 900. Once the neural network 900 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 900 to be adaptive to inputs and able to learn as more and more data is processed.

The neural network 900 is pre-trained to process the features from the data in the input layer 920 using the different hidden layers 922a, 922b, through 922n in order to provide the output through the output layer 924. In an example in which the neural network 900 is used to identify objects in images, the neural network 900 can be trained using training data that includes both images and labels. For instance, training images can be input into the network, with each training image having a label indicating the classes of the one or more objects in each image (basically, indicating to the network what the objects are and what features they have). In some examples, a training image can include an image of a number 2, in which case the label for the image can be [0 0 1 0 0 0 0 0 0 0].

In some cases, the neural network 900 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 900 is trained well enough so that the weights of the layers are accurately tuned.

For the example of identifying objects in images, the forward pass can include passing a training image through the neural network 900. The weights are initially randomized before the neural network 900 is trained. The image can include, for example, an array of numbers representing the pixels of the image. Each number in the array can include a value from 0 to 255 describing the pixel intensity at that position in the array. In some examples, the array can include a 28×28×3 array of numbers with 28 rows and 28 columns of pixels and 3 color components (such as red, green, and blue, or luma and two chroma components, or the like).

For a first training iteration for the neural network 900, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 900 is unable to determine low level features and thus cannot make an accurate determination of what the classification of the object might be. A loss function can be used to analyze error in the output. Any suitable loss function definition can be used. An example of a loss function includes a mean squared error (MSE). The MSE is defined as

$${E}_{total} = \sum \frac{1}{2} {( target - output )}^{2} ,$$

which calculates the sum of one-half times a ground truth output (e.g., the actual answer) minus the predicted output (e.g., the predicted answer) squared.

The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 900 can perform a backward pass by determining which inputs (weights) most contributed to the loss of the network, and can adjust the weights so that the loss decreases and is eventually minimized.

A derivative of the loss with respect to the weights (denoted as dL/dW, where Ware the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and η denotes a learning rate. The learning rate can be set to any suitable value, with a high learning rate including larger weight updates and a lower value indicating smaller weight updates.

The neural network 900 can include any suitable deep network. As described previously, an example of a neural network 900 includes a convolutional neural network (CNN), which includes an input layer and an output layer, with multiple hidden layers between the input and out layers. An example of a CNN is described below with respect to FIG. 10. The hidden layers of a CNN include a series of convolutional, nonlinear, pooling (for downsampling), and fully connected layers. The neural network 900 can include any other deep network other than a CNN, such as an autoencoder, a deep belief nets (DBNs), a Recurrent Neural Networks (RNNs), among others.

FIG. 10 is an illustrative example of a convolutional neural network 1000 (CNN 1000). The input layer 1020 of the CNN 1000 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1022a, an optional non-linear activation layer, a pooling hidden layer 1022b, and fully connected hidden layers 1022c to get an output at the output layer 1024. While only one of each hidden layer is shown in FIG. 10, one of ordinary skill will appreciate that multiple convolutional hidden layers, non-linear layers, pooling hidden layers, and/or fully connected layers can be included in the CNN 1000. As previously described, the output can indicate a single class of an object or can include a probability of classes that best describe the object in the image.

The first layer of the CNN 1000 is the convolutional hidden layer 1022a. The convolutional hidden layer 1022a analyzes the image data of the input layer 1020. Each node of the convolutional hidden layer 1022a is connected to a region of nodes (pixels) of the input image called a receptive field. The convolutional hidden layer 1022a can be considered as one or more filters (each filter corresponding to a different activation or feature map), with each convolutional iteration of a filter being a node or neuron of the convolutional hidden layer 1022a. For example, the region of the input image that a filter covers at each convolutional iteration would be the receptive field for the filter. In some examples, if the input image includes a 28×28 array, and each filter (and corresponding receptive field) is a 5×5 array, then there will be 24×24 nodes in the convolutional hidden layer 1022a. Each connection between a node and a receptive field for that node learns a weight and, in some cases, an overall bias such that each node learns to analyze its particular local receptive field in the input image. Each node of the hidden layer 1022a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 1022a is due to each node of the convolutional layer being applied to its corresponding receptive field. For example, a filter of the convolutional hidden layer 1022a can begin in the top-left corner of the input image array and can convolve around the input image. As noted above, each convolutional iteration of the filter can be considered a node or neuron of the convolutional hidden layer 1022a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1022a.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1022a.

The mapping from the input layer to the convolutional hidden layer 1022a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 1022a can include several activation maps in order to identify multiple features in an image. The example shown in FIG. 10 includes three activation maps. Using three activation maps, the convolutional hidden layer 1022a can detect three different kinds of features, with each feature being detectable across the entire image.

In some examples, a non-linear hidden layer can be applied after the convolutional hidden layer 1022a. The non-linear layer can be used to introduce non-linearity to a system that has been computing linear operations. One illustrative example of a non-linear layer is a rectified linear unit (ReLU) layer. A ReLU layer can apply the function ƒ(x)=max(0, x) to all of the values in the input volume, which changes all the negative activations to 0. The ReLU can thus increase the non-linear properties of the CNN 1000 without affecting the receptive fields of the convolutional hidden layer 1022a.

The pooling hidden layer 1022b can be applied after the convolutional hidden layer 1022a (and after the non-linear hidden layer when used). The pooling hidden layer 1022b is used to simplify the information in the output from the convolutional hidden layer 1022a. For example, the pooling hidden layer 1022b can take each activation map output from the convolutional hidden layer 1022a and generates a condensed activation map (or feature map) using a pooling function.

Max-pooling is an example of a function performed by a pooling hidden layer. Other forms of pooling functions be used by the pooling hidden layer 1022a, such as average pooling, L2-norm pooling, or other suitable pooling functions. A pooling function (e.g., a max-pooling filter, an L2-norm filter, or other suitable pooling filter) is applied to each activation map included in the convolutional hidden layer 1022a. In the example shown in FIG. 10, three pooling filters are used for the three activation maps in the convolutional hidden layer 1022a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 1022a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1022a having a dimension of 24×24 nodes, the output from the pooling hidden layer 1022b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1000.

The final layer of connections in the network is a fully-connected layer that connects every node from the pooling hidden layer 1022b to every one of the output nodes in the output layer 1024. Using the example above, the input layer includes 28×28 nodes encoding the pixel intensities of the input image, the convolutional hidden layer 1022a includes 3×24×24 hidden feature nodes based on application of a 5×5 local receptive field (for the filters) to three activation maps, and the pooling layer 1022b includes a layer of 3×12×12 hidden feature nodes based on application of max-pooling filter to 2×2 regions across each of the three feature maps. Extending this example, the output layer 1024 can include ten output nodes. In such an example, every node of the 3×12×12 pooling hidden layer 1022b is connected to every node of the output layer 1024.

The fully connected layer 1022c can obtain the output of the previous pooling layer 1022b (which should represent the activation maps of high-level features) and determines the features that most correlate to a particular class. For example, the fully connected layer 1022c layer can determine the high-level features that most strongly correlate to a particular class, and can include weights (nodes) for the high-level features. A product can be computed between the weights of the fully connected layer 1022c and the pooling hidden layer 1022b to obtain probabilities for the different classes. For example, if the CNN 1000 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1024 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In some examples, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 11 is a diagram illustrating an example of a system for implementing certain aspects of the present disclosure. In particular, FIG. 11 illustrates an example of computing system 1100, which can be for example any computing device making up a computing system, a camera system, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some examples, computing system 1100 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example system 1100 includes at least one processing unit (CPU or processor) 1510 and connection 1105 that couples various system components including system memory 1115, such as read-only memory (ROM) 1520 and random access memory (RAM) 1525 to processor 1110. Computing system 1100 can include a cache 1112 of high-speed memory connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms. In some instances, multimodal systems can enable a user to provide multiple types of input/output to communicate with computing system 1100. Computing system 1100 can include communications interface 1140, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 1502.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some examples, a hardware service that performs a particular function can include the software component stored in a computer-readable medium in connection with the necessary hardware components, such as processor 1110, connection 1105, output device 1135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects and examples may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects and examples in unnecessary detail. In other instances, well-known circuits, processes, algorithms, structures, and techniques may be shown without unnecessary detail in order to avoid obscuring the aspects and examples.

Individual aspects and examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative aspects and examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects and examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects and examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, then the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the present disclosure include:

Aspect 1. An apparatus for processing one or more confidence maps, the apparatus comprising: at least one memory; and at least one processor coupled to the at least one memory, the at least one processor configured to: obtain a plurality of confidence maps associated with different classes of objects, each different confidence map of the plurality of confidence maps being associated with a different class of object, wherein each confidence map includes a plurality of confidence values in a plurality of positions, each confidence value in a respective position indicating a likelihood that an object of a particular class is located in the respective position; determine a maximum value from at least a first value in a first position of a first confidence map and a second value in a first position of a second confidence map; and generate a combined confidence map for the plurality of confidence maps at least in part by including the maximum value in a first position of the combined confidence map.

Aspect 2. The apparatus of Aspect 1, wherein the at least one processor is configured to: determine a respective maximum value from each position in the plurality of confidence maps; and include each respective maximum value in each position of the combined confidence map.

Aspect 3. The apparatus of any one of Aspects 1 or 2, wherein the plurality of confidence maps is output by a machine learning model.

Aspect 4. The apparatus of any one of Aspects 1 to 3, wherein the at least one processor is configured to: process the combined confidence map to determine a plurality of bounding boxes for the different classes of objects.

Aspect 5. The apparatus of Aspect 4, wherein, to process the combined confidence map to determine the plurality of bounding boxes for the different classes of objects, the at least one processor is configured to: determine a particular number of positions in the combined confidence map having highest confidence scores; determine an initial plurality of bounding boxes for the particular number of positions; and filter the initial plurality of bounding boxes to determine the plurality of bounding boxes.

Aspect 6. The apparatus of any one of Aspects 1 to 5, wherein the at least one processor is configured to: determine a number of rows of confidence values and a number of columns of confidence values in the combined confidence map including maximum confidence values; and reduce, based on the number of rows and the number of columns in the combined confidence map including maximum confidence values, a size of the combined confidence map to generate a reduced-size confidence map.

Aspect 7. The apparatus of Aspect 6, wherein the at least one processor is configured to: process the reduced-size confidence map to determine a plurality of bounding boxes for the different classes of objects.

Aspect 8. The apparatus of Aspect 7, wherein, to process the reduced-size confidence map to determine the plurality of bounding boxes for the different classes of objects, the at least one processor is configured to: determine a particular number of positions in the reduced-size confidence map having highest confidence scores; determine an initial plurality of bounding boxes for the particular number of positions; and filter the initial plurality of bounding boxes to determine the plurality of bounding boxes.

Aspect 9. A method of processing one or more confidence maps, the method comprising: obtaining a plurality of confidence maps associated with different classes of objects, each different confidence map of the plurality of confidence maps being associated with a different class of object, wherein each confidence map includes a plurality of confidence values in a plurality of positions, each confidence value in a respective position indicating a likelihood that an object of a particular class is located in the respective position; determining a maximum value from at least a first value in a first position of a first confidence map and a second value in a first position of a second confidence map; and generating a combined confidence map for the plurality of confidence maps at least in part by including the maximum value in a first position of the combined confidence map.

Aspect 10. The method of Aspect 9, further comprising: determining a respective maximum value from each position in the plurality of confidence maps; and including each respective maximum value in each position of the combined confidence map.

Aspect 11. The method of any one of Aspects 9 or 10, wherein the plurality of confidence maps is output by a machine learning model.

Aspect 12. The method of any one of Aspects 9 to 11, further comprising: processing the combined confidence map to determine a plurality of bounding boxes for the different classes of objects.

Aspect 13. The method of Aspect 12, wherein processing the combined confidence map to determine the plurality of bounding boxes for the different classes of objects comprises: determining a particular number of positions in the combined confidence map having highest confidence scores; determining an initial plurality of bounding boxes for the particular number of positions; and filtering the initial plurality of bounding boxes to determine the plurality of bounding boxes.

Aspect 14. The method of any one of Aspects 9 to 13, further comprising: determining a number of rows of confidence values and a number of columns of confidence values in the combined confidence map including maximum confidence values; and reducing, based on the number of rows and the number of columns in the combined confidence map including maximum confidence values, a size of the combined confidence map to generate a reduced-size confidence map.

Aspect 15. The method of Aspect 14, further comprising: process the reduced-size confidence map to determine a plurality of bounding boxes for the different classes of objects.

Aspect 16. The method of Aspect 15, wherein processing the reduced-size confidence map to determine the plurality of bounding boxes for the different classes of objects comprises: determining a particular number of positions in the reduced-size confidence map having highest confidence scores; determining an initial plurality of bounding boxes for the particular number of positions; and filtering the initial plurality of bounding boxes to determine the plurality of bounding boxes.

Aspect 17. An apparatus for processing one or more confidence maps, the apparatus comprising: at least one memory; and at least one processor coupled to the at least one memory, the at least one processor configured to: obtain a confidence map associated with a class of object, the confidence map including a plurality of confidence values in a plurality of positions, each confidence value in a respective position of the confidence map indicating a likelihood that an object of the class is located in the respective position; determine a number of rows of confidence values and a number of columns of confidence values in the confidence map including maximum confidence values; and reduce, based on the number of rows and the number of columns in the confidence map including maximum confidence values, a size of the confidence map to generate a reduced-size confidence map.

Aspect 18. The apparatus of Aspect 17, wherein, to reduce the size of the confidence map based on the number of rows and the number of columns in the confidence map including maximum confidence values, the at least one processor is configured to: remove at least one row of confidence values and at least one column of confidence values from the confidence map that are not included in the number of rows of confidence values and the number of columns of confidence values in the confidence map including maximum confidence values; and maintain, in the confidence map, the number of rows of confidence values and the number of columns of confidence values in the confidence map including maximum confidence values.

Aspect 19. The apparatus of any one of Aspects 17 or 18, wherein the confidence map is a combined confidence map generated based on a plurality of confidence maps associated with different classes of objects.

Aspect 20. The apparatus of Aspect 19, wherein the at least one processor is configured to generate the combined confidence map.

Aspect 21. The apparatus of Aspect 20, wherein, to generate the combined confidence map, the at least one processor is configured to: obtain the plurality of confidence maps; determine a maximum value from at least a first value in a first position of a first confidence map and a second value in a first position of a second confidence map; and generate the combined confidence map for the plurality of confidence maps at least in part by including the maximum value in a first position of the combined confidence map.

Aspect 22. The apparatus of Aspect 21, wherein the at least one processor is configured to: determine a respective maximum value from each position in the plurality of confidence maps; and include each respective maximum value in each position of the combined confidence map.

Aspect 23. A method processing one or more confidence maps, the method comprising: obtaining a confidence map associated with a class of object, the confidence map including a plurality of confidence values in a plurality of positions, each confidence value in a respective position of the confidence map indicating a likelihood that an object of the class is located in the respective position; determining a number of rows of confidence values and a number of columns of confidence values in the confidence map including maximum confidence values; and reducing, based on the number of rows and the number of columns in the confidence map including maximum confidence values, a size of the confidence map to generate a reduced-size confidence map.

Aspect 24. The method of Aspect 23, wherein reducing the size of the confidence map based on the number of rows and the number of columns in the confidence map including maximum confidence values comprises: removing at least one row of confidence values and at least one column of confidence values from the confidence map that are not included in the number of rows of confidence values and the number of columns of confidence values in the confidence map including maximum confidence values; and maintaining, in the confidence map, the number of rows of confidence values and the number of columns of confidence values in the confidence map including maximum confidence values.

Aspect 25. The method of any one of Aspects 23 or 24, wherein the confidence map is a combined confidence map generated based on a plurality of confidence maps associated with different classes of objects.

Aspect 26. The method of Aspect 25, further comprising generating the combined confidence map.

Aspect 27. The method of Aspect 26, wherein generating the combined confidence map comprises: obtaining the plurality of confidence maps; determining a maximum value from at least a first value in a first position of a first confidence map and a second value in a first position of a second confidence map; and generating the combined confidence map for the plurality of confidence maps at least in part by including the maximum value in a first position of the combined confidence map.

Aspect 28. The method of Aspect 27, further comprising: determining a respective maximum value from each position in the plurality of confidence maps; and including each respective maximum value in each position of the combined confidence map.

Aspect 29. A non-transitory computer-readable storage medium comprising instructions stored thereon which, when executed by at least one processor, causes the at least one processor to perform operations according to any one of Aspects 9 to 16.

Aspect 30. An apparatus for processing one or more confidence maps, comprising one or more means for performing operations according to any one of Aspects 9 to 16.

Aspect 31. A non-transitory computer-readable storage medium comprising instructions stored thereon which, when executed by at least one processor, causes the at least one processor to perform operations according to any one of Aspects 23 to 28.

Aspect 32. An apparatus for processing one or more confidence maps, comprising one or more means for performing operations according to any one of Aspects 23 to 28.

What is claimed is:

1. An apparatus for processing one or more confidence maps, the apparatus comprising:
at least one memory; and
at least one processor coupled to the at least one memory, the at least one processor configured to:
obtain a plurality of confidence maps associated with different classes of objects, each different confidence map of the plurality of confidence maps being associated with a different class of object, wherein each confidence map includes a plurality of confidence values in a plurality of positions, each confidence value in a respective position indicating a likelihood that an object of a particular class is located in the respective position;
determine a maximum value from at least a first value in a first position of a first confidence map and a second value in a first position of a second confidence map; and
generate a combined confidence map for the plurality of confidence maps at least in part by including the maximum value in a first position of the combined confidence map.

2. The apparatus of claim 1, wherein the at least one processor is configured to:
determine a respective maximum value from each position in the plurality of confidence maps; and
include each respective maximum value in each position of the combined confidence map.

3. The apparatus of claim 1, wherein the plurality of confidence maps is output by a machine learning model.

4. The apparatus of claim 1, wherein the at least one processor is configured to:
process the combined confidence map to determine a plurality of bounding boxes for the different classes of objects.

5. The apparatus of claim 4, wherein, to process the combined confidence map to determine the plurality of bounding boxes for the different classes of objects, the at least one processor is configured to:
determine a particular number of positions in the combined confidence map having highest confidence scores;
determine an initial plurality of bounding boxes for the particular number of positions; and
filter the initial plurality of bounding boxes to determine the plurality of bounding boxes.

6. The apparatus of claim 1, wherein the at least one processor is configured to:
determine a number of rows of confidence values and a number of columns of confidence values in the combined confidence map including maximum confidence values; and
reduce, based on the number of rows and the number of columns in the combined confidence map including maximum confidence values, a size of the combined confidence map to generate a reduced-size confidence map.

7. The apparatus of claim 6, wherein the at least one processor is configured to:
process the reduced-size confidence map to determine a plurality of bounding boxes for the different classes of objects.

8. The apparatus of claim 7, wherein, to process the reduced-size confidence map to determine the plurality of bounding boxes for the different classes of objects, the at least one processor is configured to:
determine a particular number of positions in the reduced-size confidence map having highest confidence scores;
determine an initial plurality of bounding boxes for the particular number of positions; and
filter the initial plurality of bounding boxes to determine the plurality of bounding boxes.

9. A method of processing one or more confidence maps, the method comprising:
obtaining a plurality of confidence maps associated with different classes of objects, each different confidence map of the plurality of confidence maps being associated with a different class of object, wherein each confidence map includes a plurality of confidence values in a plurality of positions, each confidence value in a respective position indicating a likelihood that an object of a particular class is located in the respective position;
determining a maximum value from at least a first value in a first position of a first confidence map and a second value in a first position of a second confidence map; and
generating a combined confidence map for the plurality of confidence maps at least in part by including the maximum value in a first position of the combined confidence map.

10. The method of claim 9, further comprising:
determining a respective maximum value from each position in the plurality of confidence maps; and
including each respective maximum value in each position of the combined confidence map.

11. The method of claim 9, wherein the plurality of confidence maps is output by a machine learning model.

12. The method of claim 9, further comprising:
processing the combined confidence map to determine a plurality of bounding boxes for the different classes of objects.

13. The method of claim 12, wherein processing the combined confidence map to determine the plurality of bounding boxes for the different classes of objects comprises:
determining a particular number of positions in the combined confidence map having highest confidence scores;
determining an initial plurality of bounding boxes for the particular number of positions; and
filtering the initial plurality of bounding boxes to determine the plurality of bounding boxes.

14. The method of claim 9, further comprising:
determining a number of rows of confidence values and a number of columns of confidence values in the combined confidence map including maximum confidence values; and
reducing, based on the number of rows and the number of columns in the combined confidence map including maximum confidence values, a size of the combined confidence map to generate a reduced-size confidence map.

15. The method of claim 14, further comprising:
process the reduced-size confidence map to determine a plurality of bounding boxes for the different classes of objects.

16. The method of claim 15, wherein processing the reduced-size confidence map to determine the plurality of bounding boxes for the different classes of objects comprises:
determining a particular number of positions in the reduced-size confidence map having highest confidence scores;
determining an initial plurality of bounding boxes for the particular number of positions; and
filtering the initial plurality of bounding boxes to determine the plurality of bounding boxes.

17. An apparatus for processing one or more confidence maps, the apparatus comprising:
at least one memory; and
at least one processor coupled to the at least one memory, the at least one processor configured to:
obtain a confidence map associated with a class of object, the confidence map including a plurality of confidence values in a plurality of positions, each confidence value in a respective position of the confidence map indicating a likelihood that an object of the class is located in the respective position;
determine a number of rows of confidence values and a number of columns of confidence values in the confidence map including maximum confidence values; and
reduce, based on the number of rows and the number of columns in the confidence map including maximum confidence values, a size of the confidence map to generate a reduced-size confidence map.

18. The apparatus of claim 17, wherein, to reduce the size of the confidence map based on the number of rows and the number of columns in the confidence map including maximum confidence values, the at least one processor is configured to:
remove at least one row of confidence values and at least one column of confidence values from the confidence map that are not included in the number of rows of confidence values and the number of columns of confidence values in the confidence map including maximum confidence values; and
maintain, in the confidence map, the number of rows of confidence values and the number of columns of confidence values in the confidence map including maximum confidence values.

19. The apparatus of claim 17, wherein the confidence map is a combined confidence map generated based on a plurality of confidence maps associated with different classes of objects.

20. The apparatus of claim 19, wherein, to generate the combined confidence map, the at least one processor is configured to:
obtain the plurality of confidence maps;
determine a maximum value from at least a first value in a first position of a first confidence map and a second value in a first position of a second confidence map; and
generate the combined confidence map for the plurality of confidence maps at least in part by including the maximum value in a first position of the combined confidence map.
